(19) United States
(12) Patent Application Publication
(10) Pub. No.: US 2025/0245071 A1
(43) Pub. Date: Jul. 31, 2025

(54) COMPUTING SYSTEMS AND METHODS FOR DATA PROCESSING USING NON-INTERACTIVE JOB CLUSTERS

(71) Applicant: The Toronto-Dominion Bank, Toronto (CA)

(72) Inventors: Adrian Ariel IONESCU, Vaughan (CA); Andrew Kai Ming YAM, Mississauga (CA); George KNAPP, Mullica Hill, NJ (US); Parth Sanjaybhai PATEL, Kitchener (CA)

(21) Appl. No.: 18/424,091

(22) Filed: Jan. 26, 2024

(51) Int. Cl. G06F 9/50; G06F 9/48

(52) U.S. Cl. CPC G06F 9/5077; G06F 9/4881

(57) ABSTRACT

Job clusters take time to instantiate. A computing system is provided comprising a plurality of non-interactive job clusters, a control database storing a task queue, and a controller. The controller instantiates one or more clusters of the plurality of non-interactive job clusters based on a size of the task queue and monitoring if the one or more clusters are successfully instantiated. Each of the one or more clusters, after successfully being instantiated by the controller, executes a dispatcher process that includes: querying the control database to identify an available task from the task queue; obtaining and processing the available task; and, after completion of the available task, further querying the control database prior to terminating.

### TECHNICAL FIELD

The disclosed exemplary embodiments relate to computer-implemented systems and methods for data processing using non-interactive job clusters.

### BACKGROUND

A cluster is a set of computation resources and configurations to run workloads such as data engineering, data science, and data analytics workloads, such as extract, transform and load (ETL) pipelines, streaming analytics, ad-hoc analytics, and machine learning. A cluster, in some cases, includes multiple processing nodes, such as servers or virtual machines, that work together to process data in parallel. In some cases, a cluster implements a cloud data platform such as the Databricks™ platform. The workloads processed by a cluster can be executed as a set of commands in a notebook or as an automated job.

In some cases, clusters are instantiated as interactive clusters or as non-interactive “job” clusters. Generally, interactive clusters are considered “all-purpose” clusters, and can be used for data analysis collaboratively using interactive notebooks. Conversely job clusters are typically non-interactive and are used to run automated jobs.

In some cases, interactive clusters are long-lived and pre-defined, can be restarted after they terminate and can execute notebooks that are submitted sequentially. An interactive cluster can be idle (with no workload). Accordingly, interactive clusters may run for long periods of time. However, this interactivity can have several drawbacks. Multiple users may share an interactive cluster, thereby degrading each other's performance. Further, misbehaving processes may degrade performance, particularly if allowed to execute for long periods of time. Furthermore, interactive clusters are more computationally costly or computationally resource intensive to operate.

Job clusters, also herein called “non-interactive clusters” and “non-interactive job clusters”, are created with a job context and terminate when the job is complete. Once run, a job cluster cannot be restarted, nor can additional workloads be added to a job cluster. This may have certain advantages relative to interactive clusters, in that the job cluster is less likely to encounter degradation over time. In some cases, however, because a new job cluster must be instantiated for each new job, this leads to delays in spinup/startup (on the order of 5-10 minutes), which makes it impractical to start job clusters on demand for a large number of discrete workloads (e.g., processing a plurality of unrelated tasks). It will be appreciated that the terms “spinup” or “spinning up” for a cluster refers to the process of allocating physical resources (e.g., to a virtual machine) and bringing the machine into a fully operational state. The terms “spinup” and “startup” for a cluster are also interchangeably used, and do not necessarily refer to physically spinning a device.

As shown in FIG. 1, a controller 104 spins up one or more clusters 106, for example, which may be a job cluster or an interactive cluster. The controller 104 then obtains files from a database 102 and sends the files to a given cluster 106 for processing.

In some cases, there may be 3000 files to process using one or more job clusters. If each file uses its own job cluster, the amount of computing time lost to spinup/startup for each round of processing could be between 250 and 500 hours. In some cases, the required spinup/startup time makes it impractical or undesirable to use dedicated job clusters for large numbers of individual workloads.

In some cases, it is also difficult to schedule processing of the plurality of files in advance in such a way to balance the number of job clusters needed. For instance, one file may be processed in a shorter timeframe than another, therefore it can be a difficult problem to determine the sequence and positioning of different files. Still other files for processing may not be known at the time the original scheduling is performed.

Further complications can arise when a job cluster fails to instantiate correctly. Since failures are most likely to occur during spinup, having a large number of spinups multiplies the likelihood of failures. In some cases, when processing 3000 tasks daily, even a 0.1% failure rate means that 30 tasks will fail to be processed initially, and may require remedial measures to identify such failures and attempt re-execution.

### SUMMARY

The following summary is intended to introduce the reader to various aspects of the detailed description, but not to define or delimit any invention.

In at least one broad aspect, there is provided a data processing system, the system comprising: a plurality of non-interactive job clusters; a control database storing a task queue; and a controller, the controller configured to instantiate one or more clusters of the plurality of non-interactive job clusters based on a size of the task queue and to monitor when the one or more clusters are successfully instantiated. Each of the one or more clusters is configured to, after successfully being instantiated by the controller, execute a dispatcher process that queries the control database to identify an available task from the task queue, obtain and process the available task, and, after completion of the available task, further query the control database prior to terminating.

In some cases, when a given cluster of the one or more clusters is not successfully instantiated, then the given cluster is unable to execute the dispatcher process.

In some cases, after the controller determines that a given cluster of the one or more clusters is not successfully instantiated, the controller terminates the given cluster and instantiates a new cluster from amongst the plurality of non-interactive job clusters to replace the given cluster.

In some cases, when the dispatcher process determines that a further available task is available in the task queue, the dispatcher process launches the further available task.

In some cases, for a given cluster of the one or more clusters, after the dispatcher process determines that a further available task is not available in the task queue, the dispatcher process periodically executes a loop that comprises querying the control database for the further available task within a predetermined period, and after determining that the further available task is not available in the task queue within the predetermined time period, the dispatcher process terminates the given cluster.

In some cases, prior to processing the available task, the available task is tagged in the control database with an identifier of a given cluster of the one or more clusters that will be processing the available task

In some cases, following successful processing of the available task, the available task is removed from the task queue.

In some cases, following instantiation of the one or more clusters, the controller continues to monitor the size of the task queue, and in response to determining that the size exceeds a preconfigured limit, instantiates an additional cluster from amongst the plurality of non-interactive job clusters.

In some cases, the control database stores a configuration file, and wherein the controller instantiates the one or more clusters based on at least one setting of the configuration file, wherein the at least one setting is selected from a number of clusters to be used, a number of virtual central processing units (vCPUs) to be used, and a memory size to be used.

In some cases, the dispatcher process further comprises: the each of the one or more clusters determining a processing load capacity of itself; and, providing the processing load capacity to the control database to identify the available task from the task queue that has a processing load requirement that matches or is less than the processing load capacity.

In at least another broad aspect, a method for processing data is provided, the method executed in a computing environment comprising a plurality of non-interactive job clusters; a control database storing a task queue; and a controller. The method comprising: the controller instantiating one or more clusters of the plurality of non-interactive job clusters based on a size of the task queue and monitoring when the one or more clusters are successfully instantiated; and, each of the one or more clusters, after successfully being instantiated by the controller, executing a dispatcher process comprising:
querying the control database to identify an available task from the task queue; obtaining and processing the available task; and, after completion of the available task, further querying the control database prior to terminating.

In some cases, when a given cluster of the one or more clusters is not successfully instantiated, then the given cluster is unable to execute the dispatcher process.

In some cases, the method further comprising: after the controller determines that a given cluster of the one or more clusters is not successfully instantiated, the controller terminating the given cluster and instantiating a new cluster from amongst the plurality of non-interactive job clusters to replace the given cluster.

In some cases, the method further comprising: after the dispatcher process determines that a further available task is available in the task queue, the dispatcher process launches the further available task.

In some cases, for a given cluster of the one or more clusters, the method further comprising: after the dispatcher process determines that a further available task is not available in the task queue, the dispatcher process periodically executes a loop that comprises querying the control database for the further available task within a predetermined period; and after determining that the further available task is not available in the task queue within the predetermined time period, the dispatcher process terminates the given cluster.

In some cases, the method further comprising: prior to processing the available task, the control database tagging the available task with an identifier of a given cluster of the one or more clusters that will be processing the available task; and, following successful processing of the available task, the control database removing the available task from the task queue.

In some cases, the method further comprising: following instantiation of the one or more clusters, the controller continues monitoring a size of the task queue, and in response to determining that the size exceeds a preconfigured limit, the controller instantiating an additional job cluster.

In some cases, the control database stores a configuration file, and the method further comprising: the controller instantiating the one or more clusters based on at least one setting of the configuration file, wherein the at least one setting is selected from a number of clusters to be used, a number of vCPUs to be used, and a memory size to be used.

In some cases, the dispatcher process further comprising: the each of the one or more clusters determining a processing load capacity of itself; and, providing the processing load capacity to the control database to identify the available task from the task queue that has a processing load requirement that matches or is less than the processing load capacity.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of a prior-known cluster computing system;

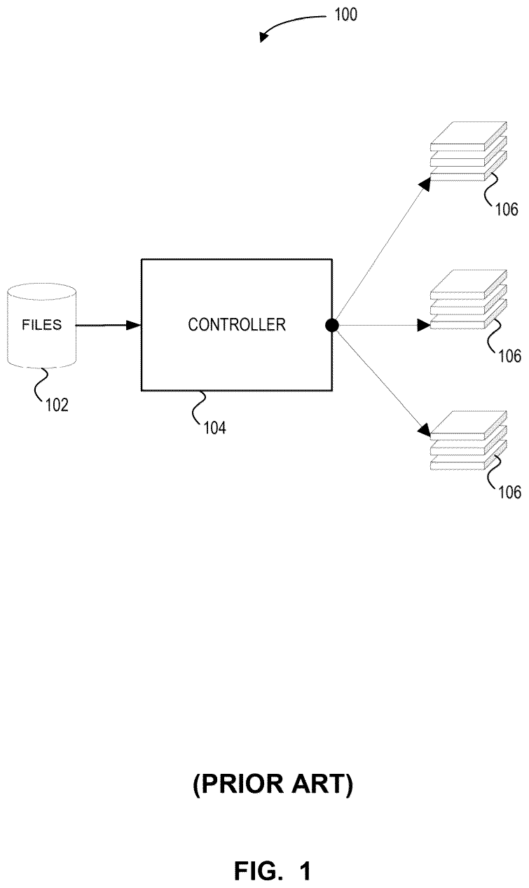

FIG. 2 is a schematic block diagram of a job cluster computing system in accordance with at least some embodiments;

FIG. 3A is a schematic block diagram of a system for processing data in accordance with at least some embodiments;

FIG. 3B is a schematic block diagram of a cloud-based computing cluster of FIG. 3A, including a controller, a controller database and a plurality of job clusters, in accordance with at least some embodiments;

FIG. 4 is a block diagram of a computer in accordance with at least some embodiments;

FIG. 5 is a flowchart diagram of an example method of processing data using a plurality of non-interactive job clusters, in accordance with at least some embodiments;

FIG. 6 is a flowchart diagram of another example method of processing data using a plurality of non-interactive job clusters, in accordance with at least some embodiments;

FIG. 7 is a flowchart diagram of another example method of processing data using a plurality of non-interactive job clusters, in accordance with at least some embodiments;

FIG. 8 is a block diagram of data components for specifying different job cluster properties, in accordance with at least some embodiments;

FIG. 9 is a block diagram of an example of varying tasks and different stages over time for instantiating job clusters, in accordance with at least some embodiments; and

FIG. 10 is a block diagram of an example of a job cluster task queue, including data components, in accordance with at least some embodiments.

### DETAILED DESCRIPTION

In some cases, a system is provided for dynamic scheduling of workloads for a plurality of job clusters.

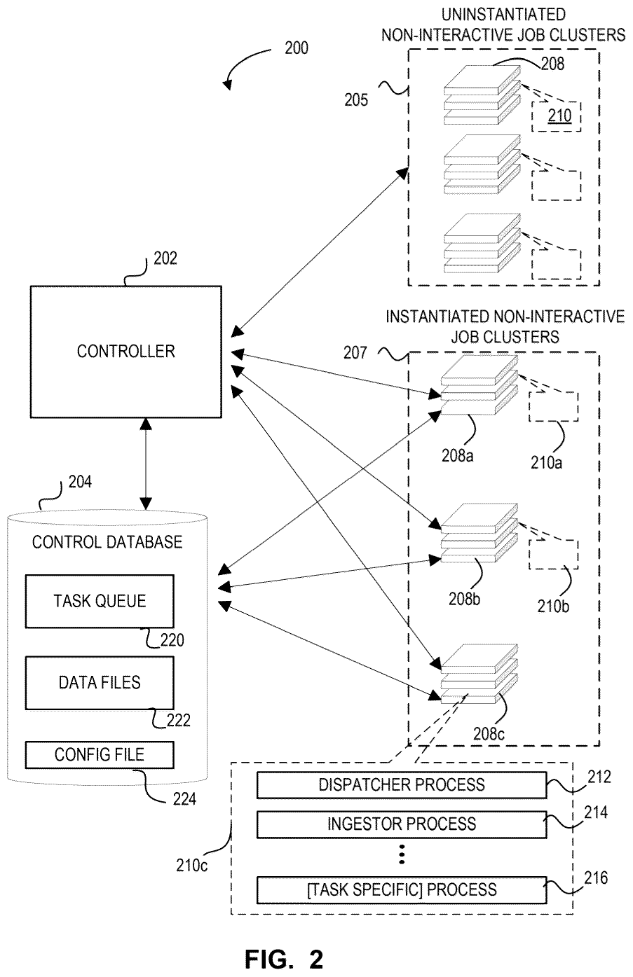

Referring to FIG. 2, a computing system 200 includes a controller 202 that is in data communication with a control database 204. The controller 202 is in data communication with one or more uninstantiated non-interactive job clusters 205 and one or more currently instantiated non-interactive job clusters 207. The control database 204 is also in data communication with each of the one or more instantiated non-interactive job clusters 207. Each of the job clusters 208 includes one or more processes 210, also called notebooks. A notebook includes executable instructions, including code and data.

In some cases, each of the instantiated non-interactive job clusters 208a, 208b, 208c respectively have their own preloaded processes 210a, 210b, 210c.

In some cases, the one or more process 210 includes a dispatcher process 212 (also called a dispatcher notebook), an ingestor process 214 (also called an ingestor notebook), and one or more other processes 216 (also called other task-specific notebooks) that are each specific to one or more other tasks to be carried out by the given job cluster.

The controller 202 adds tasks to be processed to a task queue 220 in a control database, then determines the number of job clusters needed to process the queue and instantiates the job clusters. The task queue 220 is also herein referred to as a “queue 220” and a “job cluster task queue 220”. The number of job clusters to be used may be based on a configuration file 224 which specifies computing limits, e.g., how many job clusters to instantiate per number of tasks in the queue. The configuration file 224 is stored on the controller 202, or in the control database 204, or both. Generally, the controller 202 process attempts to instantiate enough job clusters in such a manner as to not overload the available job clusters, but also minimize the number of job clusters required to complete processing of the queue.

After spun up and started, each job cluster loads a dispatcher process 212 that queries the control database 204 for a task in the queue that is to be processed. The dispatcher process 212 retrieves a task from the task queue 220 (which is then tagged in the control database 204 with the identifier of the job cluster), and launches processing of the task on the job cluster. After the processing is complete, the dispatcher process 212 updates the control database 204, where the task is removed from the task queue 220. The dispatcher process 212 checks for additional tasks in the task queue 220 which can be processed and repeats the above process. If no further tasks are available in the task queue 220, the dispatcher process 212 terminates and the job cluster is terminated. In some cases, the dispatcher process 212 waits in an idle loop for a predetermined time (e.g., 5-10 minutes) before terminating. In some cases, the amount of time to wait may be correlated with the amount of time required for spinup/startup.

In other words, if the job cluster 208a is successfully instantiated based on an initiation by the controller 202, the job cluster 208a will automatically execute the dispatcher process 212 to query the task queue 220 for an available task, and obtain the task and execute the same. This process occurs at each of the instantiated job clusters 208b, 208c. If a job cluster is attempted to be instantiated by a controller 202, but the job cluster fails to be successfully instantiated, then the job cluster is unable to execute the dispatcher process to query the task queue 220. This “seek and pull” processing of each successfully instantiated job cluster (e.g., 208a, 208b, 208c) reduces the processing of the controller 202 and reduces tasks from the control database 204 being sent to non-performing, or uninstantiated job clusters. This “seek and pull” processing also reduces tasks from the control database 204 being sent to unavailable job clusters, which may be successfully instantiated but are currently dedicating their compute resources to execute a task.

In some cases, additional tasks to be processed can be added to (or removed from) the task queue while the job clusters are already in operation. In some cases, the controller 202 monitors the task queue 220 and determines whether to spin up additional job clusters based on the number of tasks in the task queue. Likewise, the controller 202 monitors currently instantiated job clusters 207 to determine whether all have started up correctly and are operating correctly. In some cases, if a currently instantiated job cluster has failed or is non-performant, then the job cluster may be terminated and a replacement job cluster instantiated.

In some cases, the control database 204 also specifies file sizes and file types to be processed, job cluster sizes to be used, the number of vCPUs to be used in each job cluster, and so forth. A vCPU is virtual central processing unit, which is a processor of a virtual machine (VM).

The types of tasks that can be processed can range from any of the above-noted workloads to other maintenance tasks, such as table vacuuming, table optimization and so forth.

In some cases, the task queue 220 also allows for dependencies to be specified. For example, a first task may be required to be completed before a second task can begin processing. This may be specified in the control database 204.

In some cases, the controller 202 monitors for tasks that fail to complete due to inadequate resources in the selected job cluster, and instantiates a better resourced (e.g., more memory or vCPUs) job cluster to attempt the task.

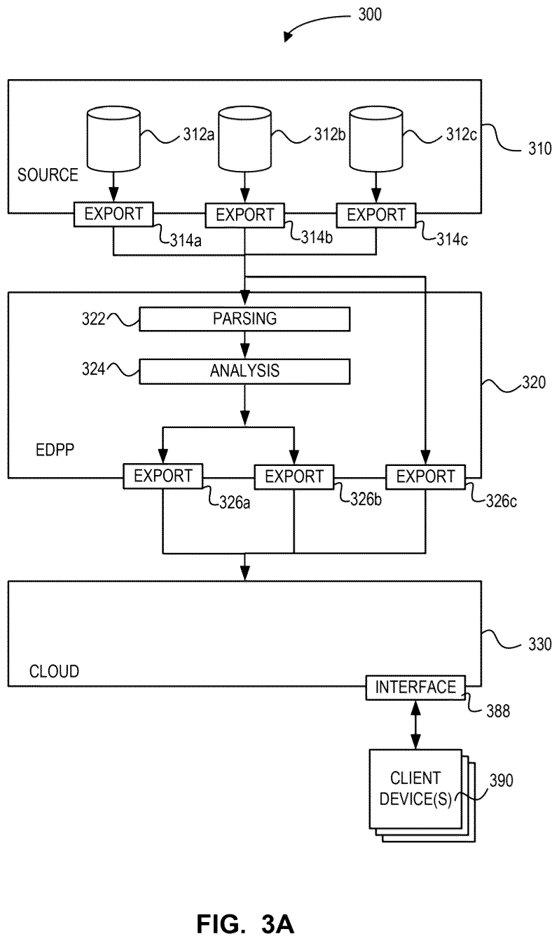

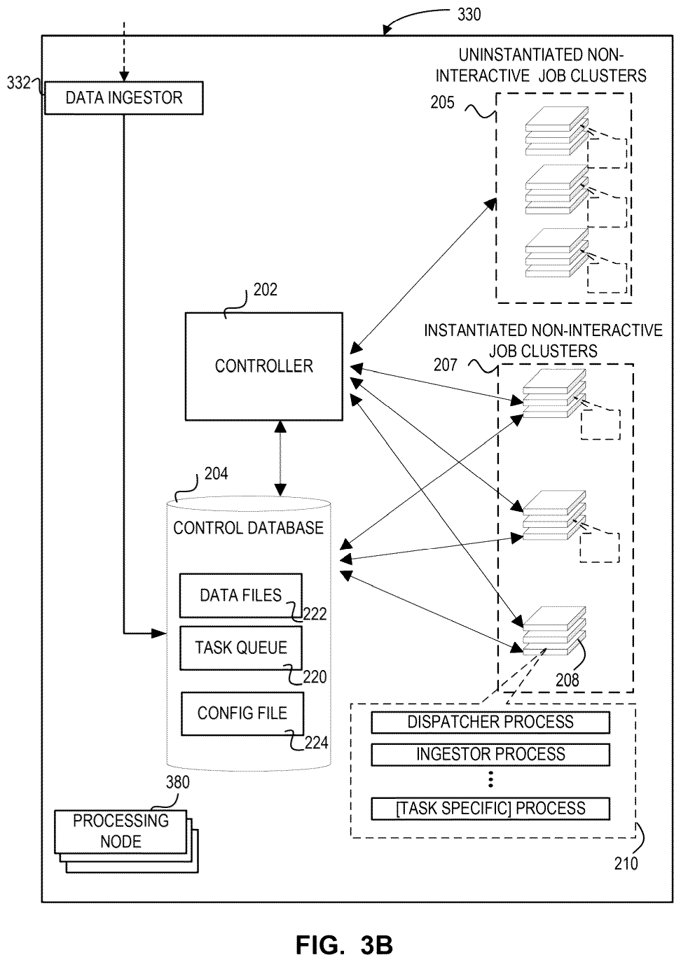

Referring now to FIG. 3A, there is illustrated a block diagram of an example computing system, in accordance with at least some embodiments. Computing system 300 has a source database system 310, an enterprise data provisioning platform (EDPP) 320 operatively coupled to the source database system 310, and a cloud-based computing cluster system 330 that is operatively coupled to the EDPP 320. In some cases. this computing system 300 is provided for automated data processing of large data sets, including computing a time series of predicted characteristics of assets identified within the large data sets.

Source database system 310 has one or more databases, of which three are shown for illustrative purposes: database 312a, database 312b and database 312c. One or more the databases of the source database system 310 may contain confidential information that is subject to restrictions on export. One or more export modules 314a, 314b, 314c may periodically (e.g., daily, weekly, monthly, etc.) export data from the databases 312a, 312b, 312c to EDPP 320. In some instances, the data is exported on an ad hoc basis. In some cases, the export data may be exported in the form of comma separated value (CSV) data, however other formats may also be used.

EDPP 320 receives source data exported by the export modules 314 of source database system 310, processes it and exports the processed data to a data ingestor within the cloud-based computing cluster system 330. For example, a parsing module 322 of EDPP 320 may perform extract, transform and load (ETL) operations on the received source data.

In many environments, access to the EDPP may be restricted to relatively few users, such as administrative users. However, with appropriate access permissions, data relevant to an application or group of applications (e.g., a client application) may be exported via reporting and analysis module 324 or an export module 326. In particular, parsed data can then be processed and transmitted to the cloud-based computing cluster system 330 by a reporting and analysis module 124. Alternatively, one or more export modules 326a, 326b, 326c can export the parsed data to the cloud-based computing cluster system 330.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 320 may “de-risk” data tables that contain confidential data prior to transmission to cloud-based computing cluster system 330. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster system 330 includes an interface 388, which facilitates data communication with one or more client devices.

Referring now to FIG. 3B, there is illustrated a block diagram of the cloud-based computing cluster system 330, showing greater detail of the elements of the cloud-based computing cluster, which may be implemented by computing nodes of the cluster that are operatively coupled.

The components of the cloud-based computing cluster system 330 include a data ingestor 332, one or more uninstatiated job clusters 205 (e.g., job clusters that are currently not instantiated and could be instantiated at a later time), one or more instantiated job clusters 207, the controller 202, and the control database 204. In some cases, these components are implemented as one or more processing nodes 380 in the cloud-based computing cluster. In some cases, these components are implemented as virtual machines within the cloud-based computing cluster.

In some cases, the data ingested by the data ingestor 332 is sent to the control database 204, and the control database 204 or the controller 202 generates a task that is stored in the task queue 220.

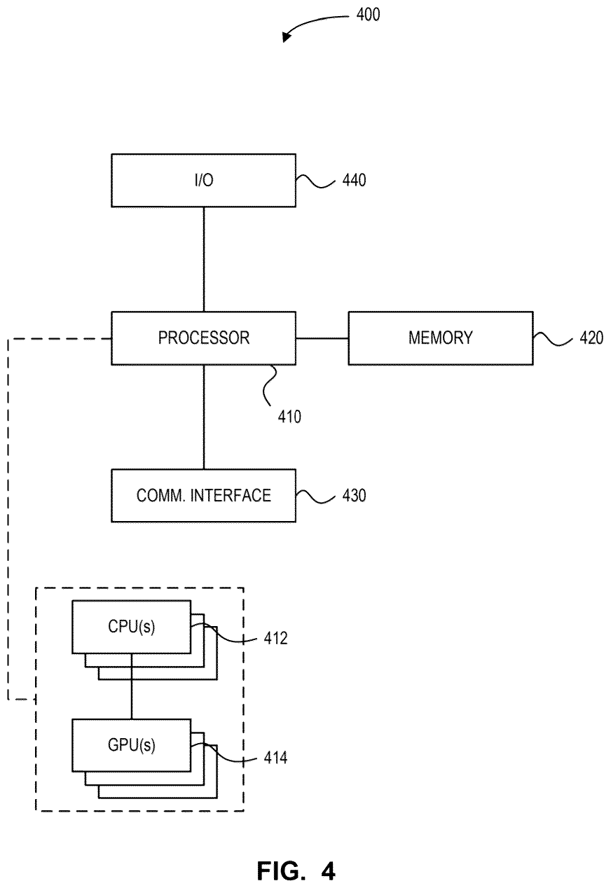

Referring now to FIG. 4, there is illustrated a simplified block diagram of a computer in accordance with at least some embodiments. Computer 400 is an example implementation of a computer such as source database system 310, EDPP 320, or a processing node 380 of FIGS. 3A and 3B, or a combination thereof. Computer 400 has at least one processor 410 operatively coupled to at least one memory 420, at least one communications interface 430 (also herein called a network interface), and at least one input/output device 440.

The at least one memory 420 includes a volatile memory that stores instructions executed or executable by processor 410, and input and output data used or generated during execution of the instructions. Memory 420 may also include non-volatile memory used to store input and/or output data-e.g., within a database-along with program code containing executable instructions.

Processor 410 may transmit or receive data via communications interface 430, and may also transmit or receive data via any additional input/output device 440 as appropriate.

In some cases, the processor 410 includes a system of central processing units (CPUs) 412. In some other cases, the processor includes a system of one or more CPUs and one or more Graphical Processing Units (GPUs) 414 that are coupled together.

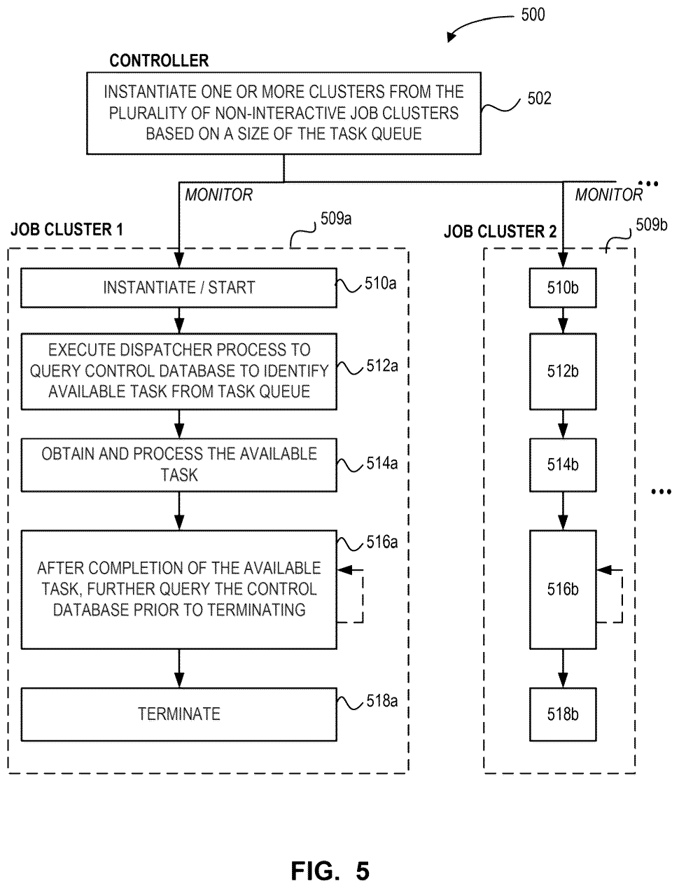

Referring now to FIG. 5, a method 500 for processing data is provided. The method is executed in a computing environment that includes a plurality of non-interactive job clusters. The computing environment also includes a control database 204 storing a task queue 220, and a controller 202. The method includes: the controller instantiating one or more clusters of the plurality of non-interactive job clusters based on a size of the task queue (block 502). In some cases, the controller also monitors if the one or more clusters are successfully instantiated. In an example, a first job cluster (e.g., called job cluster 1 in FIG. 5) executes a series of actions 509a. The series of actions 509a include job cluster 1 successfully instantiating or successfully spinning up (block 510a). Job cluster 1 then executes a dispatcher process that includes querying the control database to identify an available task from the task queue (block 512a). Job cluster 1 then obtains and processes the available task (block 514a), presuming there is an available task in the task queue. Job cluster 1, after completing the available task, further queries the control database (block 516a) prior to terminating.

In some cases, the operation of block 516a repeats over a period of time. At the end of the period of time, if there is still no available task in the task queue, then job cluster 1 terminates itself (block 518a).

In some cases, the operations 510a to 518a are part of the dispatcher process 212.

As shown in FIG. 5, a second job cluster (herein called job cluster 2) executes the same dispatcher process including the series of actions 509b. The actions or operations 510b, 512b, 514b, 516b, 518b are analogous to the blocks 510a, 512a, 514a, 516a, 518a as executed by job cluster 1. In other words, after each job cluster is successfully instantiated, the job cluster then executes the dispatcher process.

In some cases, if a given job cluster of the one or more clusters is not successfully instantiated, then the given job cluster is unable to execute the dispatcher process.

In some cases, after the controller 202 determines that a given job cluster of the one or more job clusters is not successfully instantiated, the controller 202 will then terminate the given cluster and instantiate a new job cluster from amongst the plurality of non-interactive job clusters to replace the given job cluster.

In some cases, after the dispatcher process determines that a further available task is available in the task queue 220, the dispatcher process launches the further available task.

In some cases, for a given job cluster of the one or more job clusters, after the dispatcher process determines that a further available task is not available in the task queue 220, the dispatcher process periodically executes a loop that includes querying the control database 204 for the further available task within a predetermined period. After determining that the further available task is not available in the task queue 220 within the predetermined time period, the dispatcher process then terminates the given job cluster.

In some cases, the given job cluster also terminates after a predetermined number of tasks are processed. In some cases, the predetermined number is 1000 tasks, but other numbers of tasks can be used for the predetermined number.

In some cases, if the given job cluster fails to complete task ingestion or file ingestion (e.g., the ingestor process 214) for a given task, the control database 204 clears the cluster ID tag from the task queue 220 for the given task. Another instantiated job cluster then selects the given task from the task queue 220 and processes it.

In some cases, prior to processing the available task, the control database 204 tags the available task with an identifier of a given job cluster of the one or more job clusters that will be processing the available task. Furthermore, following successful processing of the available task, the control database 204 removes the available task from the task queue 220.

In some cases, following instantiation of the one or more job clusters, the controller 202 continues monitoring a size of the task queue 220, and in response to determining that the size exceeds a preconfigured limit, the controller 202 instantiates an additional job cluster.

In some cases, the control database 204 stores a configuration file 224. The controller 202 instantiates the one or more job clusters based on at least one setting of the configuration file. In some cases, the at least one setting is a number of job clusters to be used, or is a number of vCPUs to be used, or is a memory size to be used, or is a combination thereof.

In some cases, the dispatcher process further includes: the each of the one or more clusters determining a processing load capacity of the given job cluster on which it is running, and providing the processing load capacity to the control database 204 to identify an available task from the task queue 220 that has a processing load requirement that matches or is less than the processing load capacity.

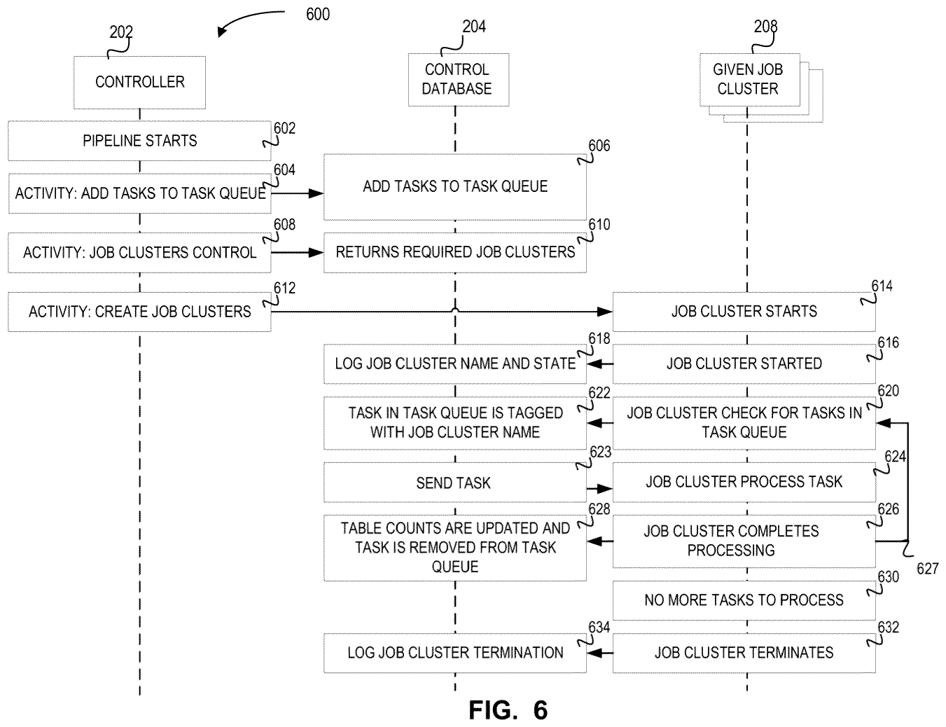

Referring to FIG. 6, a process 600 shows interactions between the controller 202, the control database 204, and a given job cluster 208, according to at least some example embodiments.

Block 602: The controller 202 initiates a data pipeline, whereby the data pipeline is used to direct data, such as tasks, to one or more instantiated job clusters.

Block 604: The controller 202 adds one or more tasks to the task queue 220, which is in the control database 204.

Block 606: The control database 204 adds the one or more tasks to the task queue 220.

Block 608: The controller 202 initiates a job cluster control operation, which in some cases includes computing the required number of job clusters to perform the tasks that are currently in the task queue 220.

Block 610: Responsive to block 608, the control database 204 determines the current number of tasks in the task queue 220 and computes the required number of job clusters to perform these tasks. The control database 204 returns the required number of job clusters to the controller 202.

Block 612: After obtaining the acquired number job clusters, the controller 202 instantiates this required number of job clusters. In some cases, the controller 202 instantiates one job cluster at a time. In some other cases, the controller 202 instantiates multiple job clusters add a time. In some other cases. the controller 202 instantiates groups of job clusters at in phases. For example, the controller 202 instantiates a first group of controllers during the first time, and then instantiate a second group of job clusters at a second time, whereby the total of the first group of job clusters and the second group of job clusters cumulatively provides the required number of job clusters.

Block 614: A given job cluster 208 is instantiated by the controller 202, or in other words is initiated to be started by the controller 202.

Block 616: The given job cluster 208 initiates a starting procedure which includes sending its job cluster name and its current state to the control database 204.

Block 618: Responsive to block 616, the control database 204 logs the job cluster name and the state. In some cases, this information is stored in the task queue 220.

Block 620: The given job cluster 208 sends a query to the control database 204 for available tasks in the task queue 220. This operation, for example, is part of a dispatcher process 212 that is executed when the given job cluster is instantiated.

Block 622: The control database 204, responsive to block 620, identifies an available task in the task queue 220 that is appropriate for the given job cluster 208. After identifying the available task, the control database 204 tags the available task with the job cluster name in the task queue 220.

Block 623: The control database 204 then provides the available task to the given job cluster 208.

Block 624: After receiving the available task from the control database 204, the given job cluster processes the available task.

Block 626: The given job cluster 208 completes processing of the available task and sends a message to the control database 204 indicating the same.

Block 628: Responsive to receiving the message regarding the completion of the formerly available task from the giving job cluster 208, the control database 204 updates the table counts and removes the formerly available task (which is now completed) from the task queue 220.

Block 627: In some cases, the given job cluster 208 will loop back to block 620 and check for further available tasks in the task queue 220 for a predefined period of time. This predefined period of time, in some cases, is approximately the same time that it would take for the given job cluster to spin up again if terminated or inactive (e.g., herein called a spinup time), or is slightly longer than the spinup time by a predefined buffer amount. If within the predefined time period the given job cluster 208 determines there are no more additional or new available tasks, then the given job cluster 208 determines that there are no more tasks to process (block 630). This operation, for example, is part of a dispatcher process 212 that is executed when the given job cluster is instantiated.

In other words, in some cases, the controller 202 and the control database 204 are used to provide and monitor the task queue 220 and instantiate and manage non-interactive job clusters used to process the task queue 220. Rather than process a single task and terminate, each non-interactive job cluster first runs a dispatcher process 212 that checks for pending tasks, executes a pending task, and repeats until the task queue 220 is empty.

In some other cases, after completing block 626, the given job cluster 208 does not check for addition or new available tasks, and proceeds to determine there are no more tasks to process (block 630).

Block 630: The given job cluster 208 determines there are no more tasks to process.

Block 632: Responsive to determining that there are no more tasks to process, the given job cluster 208 terminates itself. In other words, the given job cluster 208 is no longer active and can be later instantiated again. In some cases, as part of the termination, the given job cluster 208 will send a message to the control database 204 indicating it is now terminated. In some other cases, the control database 204 can detect the given job cluster 208 is terminated.

Block 634: After the control database 204 detects the given job cluster 208 is terminated, the control database 204 records the given job cluster's termination. In this way, the control database 204 and the controller 202 are able to determine if, in the future, the same given job cluster 208 is available to be instantiated again.

In some cases, the controller 202, the control database 204 and the given job cluster 208 operate asynchronously.

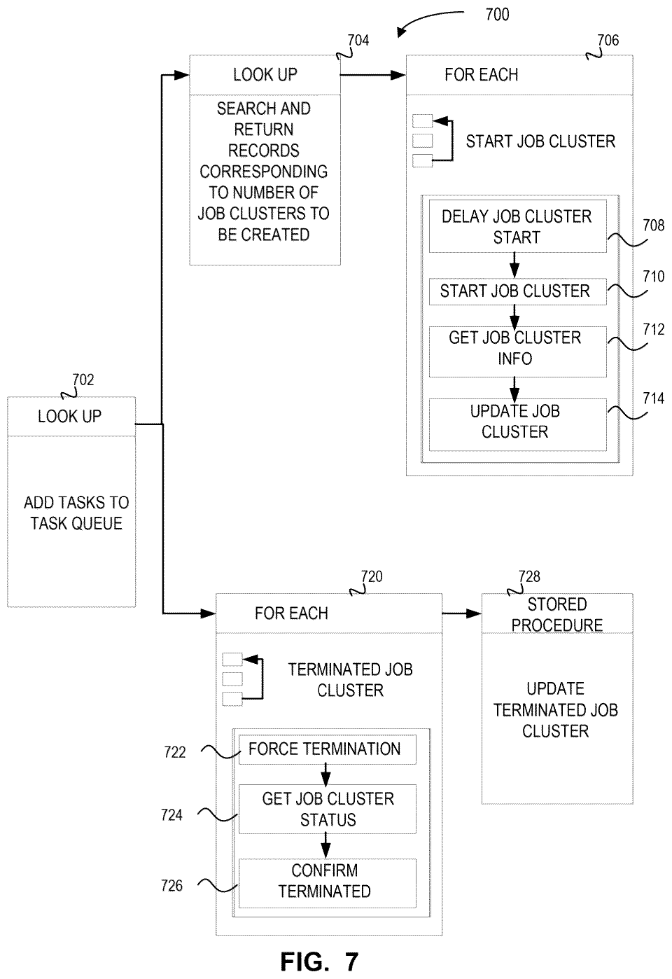

Referring now to FIG. 7, another example embodiment of a functional architecture 700 is provided for the controller, control database, and the one or more job clusters.

A look up function 702 is used to add tasks to the task queue 220. In some cases, the tasks to be added are created by the controller 202. In some other cases, data (e.g., data files 222) from the data ingestor 332 triggers one or more tasks to be automatically added to the task queue 220.

In some cases, as part of the processing of adding one or more tasks to the task queue, the controller creates a data pipeline and a pipeline file record entry that is associated with the one or more tasks to be added to the task queue. In some cases, each of the one or more tasks to be added to the task queue is associated with a control task manifest ID, so as to track the task. In some cases, the task is associated with a file.

Another look up function 704 can be executed following the look up function 702. In particular, the controller and the control database search records to determine the number of job clusters required to be created in order to execute the one or more tasks in the task queue.

A start job cluster function 706 can be executed following determining the number of job clusters required to be instantiated, as per look up function 704.

The start job cluster function 706 is executed separately for each job cluster to be instantiated. In some cases, this start job cluster function 706 is executed by the controller 202 and includes interacting with the control database 204. In some cases, the operation includes delaying the start or instantiation of the given job cluster (block 708). For example, the given job cluster 708 is earmarked or tagged to be instantiated, but is intentionally delayed, as the controller is configured to instantiate job clusters in phases (e.g., in a sequence). In other cases, there is no delay and the given job cluster is instantiated.

The controller instantiates the given job cluster (block 710). The controller obtains information about the job cluster (block 712), such as its name or ID and its status. The controller updates the status of the job cluster, for example, by associating it with a task from the task queue (block 714).

In some cases, there is a terminated cluster function 720 that is executed for each job cluster that is terminated.

In some cases, the controller receives an indication from a given job cluster, which was previously instantiated by the controller, that the given job cluster is being terminated. For example, the given job cluster in some cases can terminate itself and notify the controller as part of its termination process.

In some other cases, the controller forces the termination a given job cluster, which was previously instantiated by the controller.

In some other cases, after the controller attempts to instantiate a given job cluster and fails, the controller terminates the given job cluster.

The terminated cluster function 720, in some cases, includes the controller sending a command to a given job cluster to force the given job cluster to terminate (block 722). In some other cases, the controller receives an indicator that from the given job cluster that it is being terminated.

The controller then obtains the given job cluster's status and, in some cases, also obtains the status of any outstanding task assigned to the given job cluster (block 724). The controller, using the obtained job cluster status information, confirms that the given job cluster has been terminated (block 726). In some cases, if there is an outstanding task that was assigned to the given job cluster at the time of termination, then the outstanding task is returned to the task queue as an available task that can be executed by another job cluster.

The controller then updates its own records (e.g., which could also be stored in the control database) that the given job cluster has been terminated, as per a stored procedure function 728.

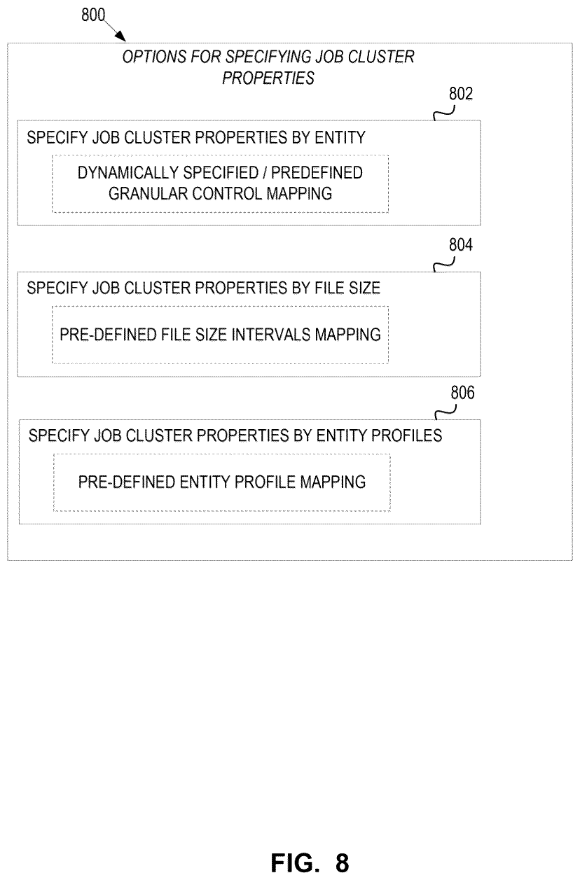

Referring now to FIG. 8, a set of options for specifying job cluster properties 800 is shown, and these options can be stored in the controller 202 or the control database 204. The controller 202 can use different decision-making criteria, which are shown as the options 802, 804 and 806 in FIG. 8, to decide which type of job clusters are used to compute a certain type of task. More generally, for a first type of task, the controller specifies a first type of job cluster; whereas for a second type of task, the controller specifies a second type of job cluster. It will be appreciated that the controller and the control database can interact with a variety of different job clusters. In some cases, some job clusters are better suited for handling larger tasks (e.g., tasks associated with larger data sizes) compared to other job clusters. In some cases, some job clusters are better suited for computing machine learning computations (e.g., neural networks) compared to other job clusters. In some cases, some job clusters are less computationally powerful, but require less computational resources to operate, compared to other job clusters. Furthermore, in some cases, job clusters have a different number of workers (or vCPUs). For example, a first job cluster has three workers, while a second job cluster has one worker. In other words, the controller may use different decision-making criteria to assign a task to a specific type of job cluster.

For option 802, the controller specifies using a certain type of job cluster based on the entity. In some cases, the entity originates the task or in some other cases the entity is associated with the task. Based on the entity, a specific type of job cluster is assigned to a given task associated with that entity. This assignment or mapping can be predefined or can be dynamically specified.

For option 804, the controller specifies using a certain type of job cluster based on the file size. In some cases, the options stores predefined file size intervals, and each interval is mapped to a specific type of job cluster.

For option 806, the controller specifies using a certain type of job cluster based on entity profiles. This is similar to option 802, but includes an intermediate mapping between one or more entities to a given profile. The given profile is then mapped to a specific type of job cluster.

Other approaches for the controller to assign a given task to a certain type of job cluster can be used and are applicable to the principles described herein.

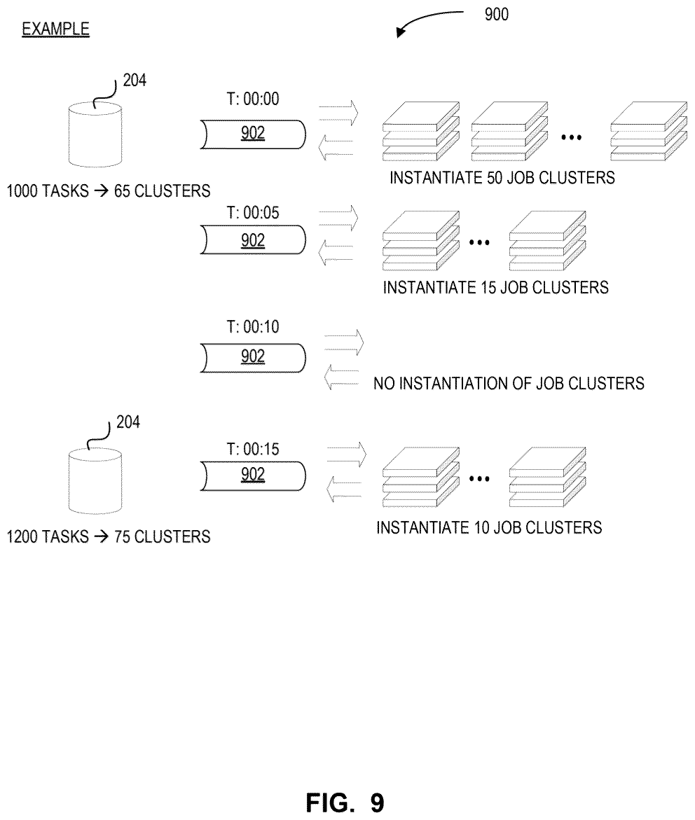

Turning to FIG. 9, an example process 900 is shown for instantiating a group of job clusters in stages. The example shows different time stages at 0 time units, 5 time units, 10 time units, and 15 time units. In some cases, the time units are minutes.

At 0 time units, the control database 204 has 1000 tasks within the task queue that are to be processed. The controller and the control database compute that 65 job clusters are required. The controller creates a data pipeline 902 to instantiate 50 job clusters at a first stage.

At 5 time units, the controller and the control database use the data pipeline 902 to instantiate 15 additional job clusters.

By instantiating separate groups of job clusters at different times, the controller can determine if there are failures amongst instantiating the first 50 job clusters and can then dynamically adjust the number of job clusters to be instantiated in at the second stage, in order to arrive at the total of 65 instantiated job clusters. For example, the controller detects that, in the first stage, 48 job clusters out of the 50 job clusters are successfully instantiated. The controller then determines that 17 job clusters need to be instantiated at the second stage to achieve the 65 instantiated job clusters.

In some cases, the time delay between instantiating the first stage, the second stage, and so forth, is approximately the same time it takes for a given job cluster to successfully spin up and execute its dispatcher process. For example, a given job cluster usually takes about 5 minutes to be successfully instantiated, so the delay between instantiating a first group of job clusters at the first stage and instantiating a second group of job clusters at the second stage is 5 minutes.

At 10 time units, no further job clusters are instantiated by the controller.

At 15 time units, 200 tasks are added to the task queue, resulting in a total of 1200 tasks in the task queue. The controller and the control database compute that a total of 75 job clusters are required to perform these tasks. In other words, an additional 10 job clusters are required to be instantiated, which are in addition to the 65 currently instantiated job clusters. The controller then instantiates an additional 10 job clusters.

For example, the controller monitors the size of the task queue, and in response to determining that the size exceeds a preconfigured limit (e.g., a limit that is based on the currently instantiated job clusters), the controller then instantiates one or more additional job clusters from amongst the non-interactive job clusters.

It will be appreciated that the controller is able to dynamically instantiate job clusters in response to detecting more tasks in the task queue, so as to meet the task load.

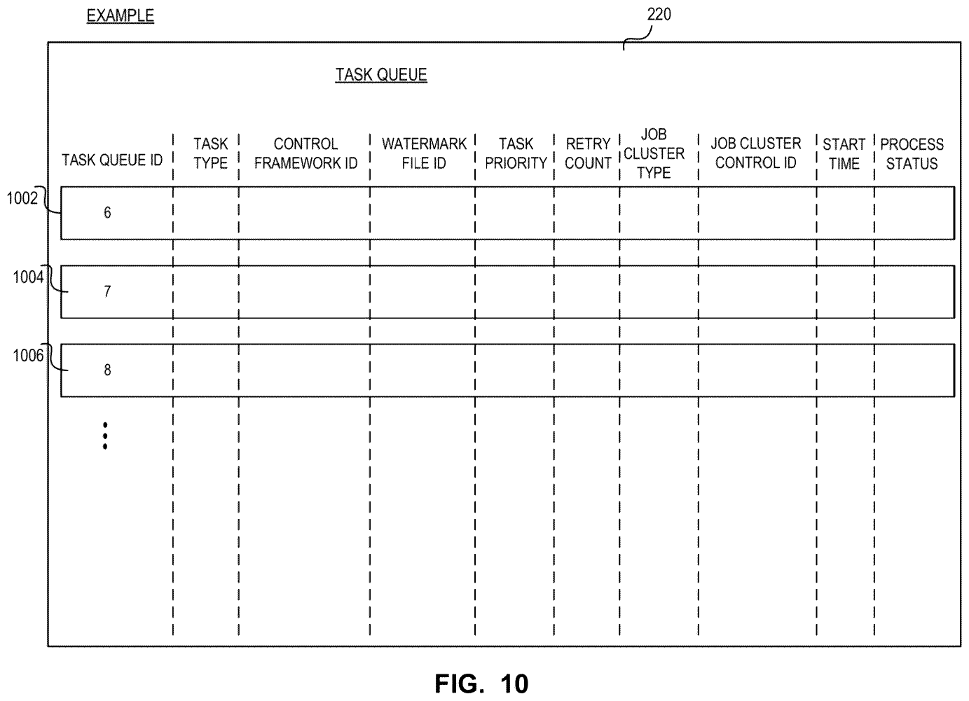

Referring now to FIG. 10, an example of data components in a task queue 220 is provided. The task queue includes a list of tasks 1002, 1004, 1006. Each task includes data components. In some cases, the data components for each task includes: a task queue ID, a task type, a control framework ID, a watermark file ID, a task priority, a retry count, a job cluster type, a job cluster control ID, a start time, and a process status.

In some cases, the task type is selected from a following group that includes:
an ingestion task, for which the dispatcher process will run an ingestor process;
an optimize task, for which the dispatcher process will run an optimize process;
a vacuum task, for which the dispatcher process will run a vacuum process;
a bulkload task, which invokes a bulkloader process;
a deploy configuration task, which starts the deploying of a config file and a scheme JSON file for a particular control framework ID record; and
a cleanup task, which includes data clean up of log files and temporary files.
   Other types of tasks can be added to this group. In some cases, each of these tasks are associated with a process that is preloaded into the processes 210 of a given job cluster 208. In some cases, these preloaded processes are also called notebooks.

In some cases, the systems and processes described herein increase computational efficiency for processing data using non-interactive job clusters. This is done, for example, by reducing the cumulative spinup time amongst multiple job clusters. In other words, by reducing the number of spinups, the job clusters can work more efficiently to process tasks from the task queue.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 312a, or 312b). All elements with a common base number may be referred to collectively or generically using the base number without a suffix (e.g., 312).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A data processing system, the system comprising:
a plurality of non-interactive job clusters;
a control database storing a task queue; and
a controller, the controller configured to instantiate one or more clusters of the plurality of non-interactive job clusters based on a size of the task queue and to monitor when the one or more clusters are successfully instantiated,
wherein each of the one or more clusters is configured to, after successfully being instantiated by the controller, execute a dispatcher process that queries the control database to identify an available task from the task queue, obtain and process the available task, and, after completion of the available task, further query the control database prior to terminating.

2. The system of claim 1, when a given cluster of the one or more clusters is not successfully instantiated, then the given cluster is unable to execute the dispatcher process.

3. The system of claim 1, wherein, after the controller determines that a given cluster of the one or more clusters is not successfully instantiated, the controller terminates the given cluster and instantiates a new cluster from amongst the plurality of non-interactive job clusters to replace the given cluster.

4. The system of claim 1, wherein, when the dispatcher process determines that a further available task is available in the task queue, the dispatcher process launches the further available task.

5. The system of claim 1, wherein, for a given cluster of the one or more clusters, after the dispatcher process determines that a further available task is not available in the task queue, the dispatcher process periodically executes a loop that comprises querying the control database for the further available task within a predetermined period, and after determining that the further available task is not available in the task queue within the predetermined time period, the dispatcher process terminates the given cluster.

6. The system of claim 1, wherein prior to processing the available task, the available task is tagged in the control database with an identifier of a given cluster of the one or more clusters that will be processing the available task

7. The system of claim 1, wherein the plurality of non-interactive job clusters implements a machine learning model.

8. The system of claim 1, wherein following instantiation of the one or more clusters, the controller continues to monitor the size of the task queue, and in response to determining that the size exceeds a preconfigured limit, instantiates an additional cluster from amongst the plurality of non-interactive job clusters.

9. The system of claim 1, wherein the control database stores a configuration file, and wherein the controller instantiates the one or more clusters based on at least one setting of the configuration file, wherein the at least one setting is selected from a number of clusters to be used, a number of vCPUs to be used, and a memory size to be used.

10. The system of claim 1, wherein the dispatcher process further comprises:
the each of the one or more clusters determining a processing load capacity of itself; and,
providing the processing load capacity to the control database to identify the available task from the task queue that has a processing load requirement that matches or is less than the processing load capacity.

11. A method for processing data, the method executed in a computing environment comprising a plurality of non-interactive job clusters; a control database storing a task queue; and a controller, and the method comprising:
the controller instantiating one or more clusters of the plurality of non-interactive job clusters based on a size of the task queue and monitoring when the one or more clusters are successfully instantiated;
each of the one or more clusters, after successfully being instantiated by the controller, executing a dispatcher process comprising:
querying the control database to identify an available task from the task queue;
obtaining and processing the available task; and,
after completion of the available task, further querying the control database prior to terminating.

12. The method of claim 11, wherein when a given cluster of the one or more clusters is not successfully instantiated, then the given cluster is unable to execute the dispatcher process.

13. The method of claim 11, further comprising: after the controller determines that a given cluster of the one or more clusters is not successfully instantiated, the controller terminating the given cluster and instantiating a new cluster from amongst the plurality of non-interactive job clusters to replace the given cluster.

14. The method of claim 11, further comprising: after the dispatcher process determines that a further available task is available in the task queue, the dispatcher process launches the further available task.

15. The method of claim 11, wherein, for a given cluster of the one or more clusters, the method further comprising: after the dispatcher process determines that a further available task is not available in the task queue, the dispatcher process periodically executes a loop that comprises querying the control database for the further available task within a predetermined period; and after determining that the further available task is not available in the task queue within the predetermined time period, the dispatcher process terminates the given cluster.

16. The method of claim 11, further comprising: prior to processing the available task, the control database tagging the available task with an identifier of a given cluster of the one or more clusters that will be processing the available task; and, following successful processing of the available task, the control database removing the available task from the task queue.

17. The method of claim 11, further comprising: following instantiation of the one or more clusters, the controller continues monitoring a size of the task queue, and in response to determining that the size exceeds a preconfigured limit, the controller instantiating an additional job cluster.

18. The method of claim 11, wherein the control database stores a configuration file, and the method further comprising: the controller instantiating the one or more clusters based on at least one setting of the configuration file, wherein the at least one setting is selected from a number of clusters to be used, a number of vCPUs to be used, and a memory size to be used.

19. The method of claim 11, wherein the dispatcher process further comprising:
the each of the one or more clusters determining a processing load capacity of itself; and,
providing the processing load capacity to the control database to identify the available task from the task queue that has a processing load requirement that matches or is less than the processing load capacity.

20. A non-transitory computer readable medium storing computer executable instructions which, when executed by at least one computer processor, cause the at least one computer processor to carry out a method for processing data, the non-transitory computer readable medium further storing thereon at least a control database that stores a task queue, and the method comprising:
instantiating, using a controller, one or more clusters of a plurality of non-interactive job clusters based on a size of the task queue and monitoring when the one or more clusters are successfully instantiated;
after successfully being instantiated by the controller, executing a dispatcher process for each of the one or more clusters, the dispatcher process comprising:
querying the control database to identify an available task from the task queue;
obtaining and processing the available task; and,
after completion of the available task, further querying the control database prior to terminating.
